(19) United States
(12) Patent Application Publication
(10) Pub. No.: US 2023/0344010 A1
(43) Pub. Date: Oct. 26, 2023

(54) DEEP-EUTECTIC-SOLVENT-BASED (DES) ELECTROLYTES FOR CATHODE/SOLID ELECTROLYTE INTERFACES IN SOLID-STATE BATTERIES

(71) Applicants: CORNING INCORPORATED, CORNING, NY (US); Shanghai Institute of Ceramics, Chinese Academy of Sciences, Shanghai (CN)

(72) Inventors: Michael Edward Badding, Campbell, NY (US); Mingli Cai, Nantong (CN); Jun Jin, Shanghai (CN); Zhen Song, Painted Post, NY (US); Zhaoyin Wen, Shanghai (CN); Tongping Xiu, Shanghai (CN); Liu Yao, Shanghai (CN)

(21) Appl. No.: 18/136,603

(22) Filed: Apr. 19, 2023

(30) Foreign Application Priority Data
Apr. 20, 2022 (CN) 202210414261.2

(51) Int. Cl. H01M 4/58; H01M 4/525; H01M 10/0562; H01M 4/36; H01M 10/0569; H01M 4/505; H01M 4/131

(52) U.S. Cl. CPC H01M 10/0569; H01M 4/131; H01M 4/366; H01M 4/505; H01M 4/525; H01M 4/5825; H01M 10/0562; H01M 2300/0028; H01M 2300/0071; H01M 2300/0094

(57) ABSTRACT

A battery includes a substrate; a cathode disposed on the substrate; at least one interlayer disposed on the cathode; a solid-state electrolyte (SSE) disposed on the interlayer; and a lithium anode disposed on the solid-state electrolyte, such that the at least one interlayer is a deep-eutectic-solvent-based (DES) electrolyte.

### CROSS-REFERENCE TO RELATED APPLICATIONS

This application claims the benefit of priority to Chinese Patent Application Serial No. 202210414261.2 filed on Apr. 20, 2022, the content of which is relied upon and incorporated herein by reference in its entirety.

### BACKGROUND

### 1. Field

This disclosure relates to deep eutectic solvent-based (DES) electrolytes for cathode/solid electrolyte interfaces in solid-state batteries and methods of manufacturing thereof.

### 2. Technical Background

Solid-state batteries (SSBs) (e.g., SS lithium (Li) metal batteries based on inorganic solid-state electrolytes (SSEs) (such as garnet-type SSE)) have attracted much attention due to their high safety, improved energy density, high ionic conductivity, and stability against Li metal.

However, conventional Li-metal batteries often suffer from high interfacial resistance between the cathode and solid-state electrolyte. Due to the rigid nature of the ceramic SSE, contact between active particles and the SSE is a “point-surface” contact, which leads to a limited contact area at the cathode-SSE interface and poor Li-ion (Li⁺) accessibility inside the cathode.

To address these problematic issues, proposed solutions include employing a low melting compound (e.g., Li₃BO₃ (LBO), Li_{2.3-x}C_{0.7+x}B_{0.3-x}O₃ (LCBO), etc.) as a bonding material and Li-ion conductor to lower the cathode/SSE interfacial resistance. Additionally, a Li-ion conductive polymer-lithium salt in a polymer matrix (Li(CF₃SO₂)₂N (LiTFSI) in poly(vinylidene fluoride) (PVDF), polyethylene oxide (PEO), poly(ethylene glycol) methyl ether acrylate (CPMEA), etc.) may be used to cushion the poor contact at cathode/SSE interface. However, the above-proposed configurations all exhibit low Li-ion conductivity, large impedance, and low current density at battery operating conditions.

The present application discloses improved deep eutectic solvent-based (DES) electrolytes for cathode/solid electrolyte interfaces in solid-state battery applications.

### SUMMARY

In embodiments, a battery, comprises: a substrate; a cathode disposed on the substrate; at least one interlayer disposed on the cathode; a solid-state electrolyte (SSE) disposed on the interlayer; and a lithium anode disposed on the solid-state electrolyte, wherein the at least one interlayer is a deep-eutectic-solvent-based (DES) electrolyte.

In aspects, which are combinable with any of the other aspects or embodiments, the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof. In aspects, which are combinable with any of the other aspects or embodiments, the cathode comprises: lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

In aspects, which are combinable with any of the other aspects or embodiments, the deep-eutectic-solvent-based (DES) electrolyte comprises at least one lithium salt and at least one amide compound. In aspects, which are combinable with any of the other aspects or embodiments, the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof. In aspects, which are combinable with any of the other aspects or embodiments, the at least one amide compound comprises at least one of: R₁—CO—NH—R₂, R₁—O—CO—NH—R₂, NH₂—CO—NH—R₂, NH₂—CS—NH—R₂, wherein R₁ is selected from CH₃—(CH₂)ₙ and CH₂═CH—(CH₂)ₙ, and n is in a range of 0 to 10, and R₂ is selected from H, CH₃, and CH₂-OH. In aspects, which are combinable with any of the other aspects or embodiments, the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA). In aspects, which are combinable with any of the other aspects or embodiments, a molar ratio of LiTFSI:NMA is in a range of 1:1 to 1:50.

In aspects, which are combinable with any of the other aspects or embodiments, the solid-state electrolyte comprises lithium, lanthanum, zirconium, and oxygen elements. In aspects, which are combinable with any of the other aspects or embodiments, the solid-state electrolyte comprises at least one of: (i) Li₇₋₃ₐLa₃Zr₂LₐOı₂, with L = Al, Ga or Fe and 0 < a < 0.33; (ii) Li₇La_{3-b}Zr₂M_{b}O₁₂, with M = Bi or Y and 0 < b < 1; (iii) Li_{7-c}La₃(Zr_{2-c},N_{c})O₁₂, with N = In, Si, Ge, Sn, V, W, Te, Nb, or Ta and 0 < c < 1; (iv) protonated LLZO (e.g., Hₓ-Li_{6.5-}ₓLa₃Zr_{1.5}I_{0.5}O₁₂, with I = In, Si, Ge, Sn, V, W, Te, Nb, or Ta and 0 < x < 4 or Hₓ-Li_{6.25-}ₓE_{0.25}La₃Zr₂Oₗ₂, with E = Al, Ga or Fe and 0 < x < 4), or a combination thereof.

In aspects, which are combinable with any of the other aspects or embodiments, the battery has a cathode/SSE interfacial resistance of no more than 200 Ω cm² at room temperature and a cycling stability of at least 200 cycles with at least 50% capacity retention. In aspects, which are combinable with any of the other aspects or embodiments, the battery has a cathode/SSE interfacial resistance of no more than 130 Ω cm² at room temperature and a cycling stability of at least 400 cycles with at least 80% capacity retention.

In aspects, which are combinable with any of the other aspects or embodiments, the at least one interlayer is disposed as an independent layer. In aspects, which are combinable with any of the other aspects or embodiments, the at least one interlayer is embedded at a depth within the cathode, or embedded at a depth within the solid-state electrolyte (SSE), or any combination thereof.

In embodiments, a battery, comprises: a cathode; at least one interlayer disposed on the cathode; a solid-state electrolyte (SSE) disposed on the interlayer, wherein the at least one interlayer is a deep-eutectic-solvent-based (DES) electrolyte, and wherein the battery has: a cathode/SSE interfacial resistance of no more than 200 Ω cm² at room temperature, and a cycling stability of at least 200 cycles with at least 50% capacity retention.

In aspects, which are combinable with any of the other aspects or embodiments, the cathode/SSE interfacial resistance is no more than 130 Ω cm² at room temperature and the cycling stability is at least 400 cycles with at least 80% capacity retention.

In aspects, which are combinable with any of the other aspects or embodiments, the cathode comprises at least one of: lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof. In aspects, which are combinable with any of the other aspects or embodiments, the cathode comprises: lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

In aspects, which are combinable with any of the other aspects or embodiments, the deep-eutectic-solvent-based (DES) electrolyte comprises at least one lithium salt and at least one amide compound. In aspects, which are combinable with any of the other aspects or embodiments, the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof. In aspects, which are combinable with any of the other aspects or embodiments, the at least one amide compound comprises at least one of: R₁-CO-NH-R₂, R₁-O-CO-NH-R₂, NH₂-CO-NH-R₂, NH₂-CS-NH-R₂, wherein R₁ is selected from CH₃-(CH₂)ₙ and CH₂=CH-(CH₂)ₙ, and n is in a range of 0 to 10, and R₂ is selected from H, CH₃, and CH₂-OH.

In aspects, which are combinable with any of the other aspects or embodiments, the at least one interlayer is disposed as an independent layer. In aspects, which are combinable with any of the other aspects or embodiments, the at least one interlayer is embedded at a depth within the cathode, or embedded at a depth within the solid-state electrolyte (SSE), or any combination thereof.

In aspects, which are combinable with any of the other aspects or embodiments, the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA). In aspects, which are combinable with any of the other aspects or embodiments, a molar ratio of LiTFSI:NMA is in a range of 1:1 to 1:50.

In aspects, which are combinable with any of the other aspects or embodiments, the solid-state electrolyte comprises at least one of: (i) Li₇₋₃ₐLa₃Zr₂LₐOı₂, with L = Al, Ga or Fe and 0 < a < 0.33; (ii) Li₇La_{3-b}Zr₂M_{b}O₁₂, with M = Bi or Y and 0 < b < 1; (iii) Li_{7-c}La₃(Zr₂₋_{c},N_{c})O₁₂, with N = In, Si, Ge, Sn, V, W, Te, Nb, or Ta and 0 < c < 1; (iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4), or a combination thereof.

### BRIEF DESCRIPTION OF THE DRAWINGS

The disclosure will become more fully understood from the following detailed description, taken in conjunction with the accompanying figures, in which:

FIG. 1 illustrates a general structure of a solid-state battery, according to embodiments.

FIGS. 2A and 2B illustrate ionic conductivities of DES electrolytes with varying molar ratios (at room temperature, RT) (FIG. 2A) and varying temperatures (FIG. 2B); FIG. 2C shows Raman spectroscopy results of DES electrolytes with different molar ratios; and FIG. 2D shows viscosity of DES electrolytes with different molar ratios, according to embodiments.

FIG. 3A is a schematic representation of optical images of LiPF₆ in ethylene carbonate (EC) / dimethyl carbonate (DMC) electrolyte and DES electrolyte under a combustion test; FIG. 3B illustrates mass loss curves of LiPF₆ in EC/DMC electrolyte and DES electrolyte at different temperatures; and FIG. 3C illustrates mass loss curves of LiPF₆ in EC/DMC electrolyte and DES electrolyte at RT in the air, according to embodiments.

FIG. 4A illustrates a schematic diagram of a full battery with DES electrolyte at LFP/SSE interface; FIG. 4B illustrates an EIS spectrum and FIG. 4C illustrates a voltage-capacity curve of a LFP/DES/LLZTO/Li cell; and FIG. 4D illustrates long-term cycling performance of the LFP/DES/LLZTO/Li cell at RT, according to embodiments.

FIG. 5A illustrates a schematic diagram of a full battery with DES electrolyte at NCM/SSE interface; FIG. 5B illustrates voltage-capacity curves of a NCM622/DES/LLZTO/Li cell at different rates; and cycling performance of the NCM622/DES/LLZTO/Li cell is illustrated at different rates (FIG. 5C) and at 0.25C at RT (FIG. 5D), according to embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

“LLZO” or like terms refer to compounds comprising lithium, lanthanum, zirconium, and oxygen elements. For example, lithium-garnet electrolyte comprises at least one of: (i) Li₇₋₃ₐLa₃Zr₂LₐOı₂, with L = Al, Ga or Fe and 0 < a < 0.33; (ii) Li₇La_{3-b}Zr₂M_{b}O₁₂, with M = Bi or Y and 0 < b < 1; (iii) Li_{7-c}La₃(Zr_{2-c},N_{c})O₁₂, with N = In, Si, Ge, Sn, V, W, Te, Nb, or Ta and 0 < c < 1; (iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{O.25}La₃Zr₂O₁₂, with E = Al, Ga or Fe and 0 < x < 4), or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Aimed at solving the problems defined above, one approach to achieve relatively low interfacial resistance at room temperature (RT) is to employ gel polymer electrolyte (GPE)-liquid electrolyte trapped in polymer matrix, which possesses high RT Li-ion conductivity and mechanical flexibility. For example, PEO-based GPE has been used as a buffer layer between the cathode and solid electrolyte as an attempt to reduce interfacial resistance and improve cycling performance at room temperature. However, one problem of such cell configurations is that the GPE is directly introduced at the cathode-electrolyte interface, leading to a relatively thick interlayer and the lack of electrolyte inside the cathode. Thus, this approach is impractical.

Liquid electrolytes are advantageous in wetting the cathode/SSE interface, due to it having high ionic conductivity and can provide continuous and uniform ion paths at the interface and inside the cathode. For example, ionic liquid electrolytes can be employed to prepare toothpaste-like composite cathodes, which can effectively reduce the interfacial resistance and greatly improve cycling performance. However, ionic liquid electrolytes are expensive and not desirable for large-scale applications. Thus, there is a need for high safety, low cost liquid electrolytes for cathode/SSE interfaces.

The present application discloses improved deep eutectic solvent-based (DES) electrolytes for cathode/solid electrolyte interfaces in solid-state battery applications. More specifically, a deep-eutectic-solvent-based (DES) electrolyte is disclosed for use at the cathode/SSE interface, which includes lithium salts and amide compounds, where the molar ratio of the lithium salt to the amide compound is about 1:1-1:50. DES electrolytes are solvents of a binary or multivariate system mainly composed of hydrogen bond donors and hydrogen bond acceptors. Due to their intermolecular hydrogen bonds, the melting point of the system decreases, and a solvent may be obtained in liquid state at room temperature. DES electrolytes have high ionic conductivity, low vapor pressure, low cost, non-flammability and biodegradability, and can remain in a liquid state at room temperature, owing to intermolecular hydrogen bonds between lithium salt as hydrogen-bond acceptor and amide compound as hydrogen-bond donor. With DES electrolytes at cathode/SSE interface, solid-state batteries can achieve greatly reduced interfacial resistance of ~130 Ω cm² at RT and excellent cycling stability, which can maintain ~80% capacity retention after ~400 cycles.

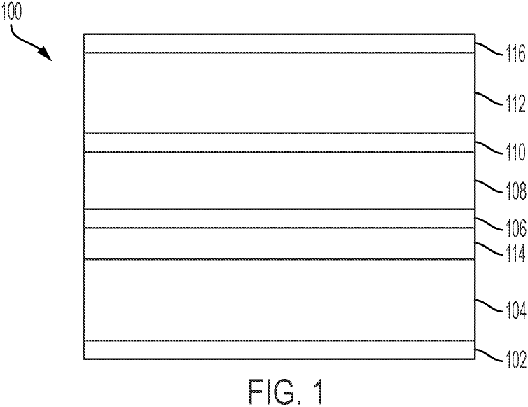

FIG. 1 illustrates a general structure of a solid-state battery, according to some embodiments. It will be understood by those of skill in the art that the processes described herein can be applied to other configurations of solid-state battery structures.

In some embodiments, battery 100 may include a substrate 102 (e.g., a current collector), an electrode (e.g., cathode) 104 disposed on the substrate, an optional coating layer 114 disposed on the cathode, an optional first interlayer 106 disposed on the coating layer, a solid-state electrolyte 108 disposed on the first interlayer, an optional second interlayer 110 disposed on the electrolyte, a lithium electrode (e.g., anode) 112 disposed on the second interlayer, and a second current collector 116 disposed on the anode. These can be disposed horizontally in relation to each other or vertically.

In examples, the substrate 102 may a current collector including at least one of three-dimensional nickel (Ni) foam, carbon fiber, foils (e.g., aluminum, stainless steel, copper, platinum, nickel, etc.), or a combination thereof.

In examples, the interlayer 106 and 110 may be independently chosen from at least one of carbon-based interlayers (e.g., interlinked freestanding, micro/mesopore containing, functionalized, biomass derived), polymer-based interlayers (e.g., polyethylene oxide (PEO), polypyrrole (PPY), polyvinylidene fluoride, etc.), metal-based (e.g., Ni foam, etc.), liquid electrolytes (e.g., LiPF₆ in ethylene carbonate (EC)/dimethyl carbonate (DMC)), ionic liquid-based (e.g., LiCF₃SO₃/CH₃CONH₂, LiTFSI/N-methylacetamide (NMA), PEO₁₈LiTFSI-10%SiO₂-10%IL, etc., where PEO is polyethylene oxide, LiTFSI is bis(trifluoromethane) sulfonimide lithium salt (LiN(CF₃SO₂)₂), and SiO₂ may be nanoparticles; and ionic liquid), or a combination thereof. Methods of formation of the interlayer are described in the Examples below.

In embodiments, the interlayer 106 (e.g., DES electrolyte) may be present (i) as an independent layer at the cathode 104 and solid-state electrolyte 108 interface or (ii) enveloped at some depth within the cathode 104 or (iii) enveloped at some depth within the solid-state electrolyte 108 or (iv) any combination of (i)-(iii).

In examples, solid-state electrolyte 108 may be used to address common safety concerns such as leakage, poor chemical stability, and flammability often seen in batteries employing liquid electrolytes. Moreover, solid-state electrolytes can also suppress polysulfide shuttling from the cathode to the anode, thereby leading to improved cathode utilization and a high discharge capacity and energy density. In examples, the solid-state electrolyte may include compounds comprising lithium, lanthanum, zirconium, and oxygen elements, collectively “LLZO.” For example, the solid-state, lithium-garnet electrolyte may comprise at least one of: (i) Li₇₋₃ₐLa₃Zr₂LₐOı₂, with L = Al, Ga or Fe and 0 < a < 0.33; (ii) Li₇La₃₋_{b}Zr₂M_{b}O₁₂, with M = Bi or Y and 0 < b < 1; (iii) Li_{7-c}La₃(Zr_{2-c},N_{c})O₁₂, with N = In, Si, Ge, Sn, V, W, Te, Nb, or Ta and 0 < c < 1; (iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4), or a combination thereof.

In examples, the solid-state electrolyte may include at least one of Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof. Methods of formation of the electrolyte 108 are described in the Examples below.

In examples, the anode 112 may comprise lithium (Li) metal. In examples, the battery may include at least one anode protector such as electrolyte additives (e.g., LiNO₃, lanthanum nitrate, copper acetate, P₂S₅, etc.), artificial interfacial layers (e.g., Li₃N, (CH₃)₃SiCl, A1₂O₃, LiAl, etc.), composite metallics (e.g., Li₇B₆, Li-rGO (reduced graphene oxide), layered Li-rGO, etc.), or combinations thereof. In examples, a thin layer of metal (e.g., Au) may be ion-sputter coated to form a contact interface between the anode 112 and first interlayer 106 or between the anode and solid-state electrolyte 108. In examples, a thin layer of silver (Ag) paste may be brushed to a surface of the solid-state electrolyte 108 to form a close contact between the anode 112 and solid-state electrolyte 108.

In examples, the coating layer 114 may comprise at least one of carbon polysulfides (CS), polyethylene oxides (PEO), polyaniline (PANI), polypyrrole (PPY), poly(3,4-ethylenedioxythiophene) (PEDOT), polystyrenesulfonic acid (PSS), polyacrylonitrile (PAN), polyacrylic acid (PAA), polyallylamine hydrochloride (PAH), poly(vinylidene fluoride-co-hexafluoropropylene) (P(VdF-co-HFP)), poly(methylmethacrylate) (PMMA), polyvinylidene fluoride (PVDF), poly(diallyldimethyl ammonium) bis(trifluoromethanesulfonyl)imide (TFSI) (PDDATFSI), or combinations thereof, and at least one lithium salt (e.g., bis(trifluoromethane) sulfonimide lithium salt (LiN(CF₃SO₂)₂)(LiTFSI), lithium perchlorate, lithium bis(oxalato) borate (LiBOB), lithium bis(fluorosulfonyl)imide (LiFSI), lithium trifluoromethanesulfonate (LiCF₃SO₃) (LiTf), lithium bis(trifluoromethanesulfonimide) (Li(C₂F₅SO₂)₂N) (LiBETI), or combinations thereof). In examples, the coating layer may additionally comprise at least one of, or at least two of, or at least three of nitrogen, carbon, cobalt, titanium, tantalum, and tungsten.

In examples, the cathode 104 may comprise at least one of a lithium-based electrode including lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1, such as LiNi_{0.5}Co_{0.2}Mn_{0.3}O₂ (NCM523), LiNi_{0.6}Co_{0.2}Mn_{0.2}O₂ (NCM622), etc.), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof. In examples, the cathode 104 may comprise at least one of a sodium-based electrode include NaVPO₄F, NaMnO₂, Na_{⅔}Mn_{1-y}Mg_{y}O₂ (0 < y < 1), Na₂Li₂Ti₅O₁₂, Na₂Ti₃O₇, or combinations thereof. In examples, the cathode 104 may comprise at least one of a magnesium-based include magnesiochromite (MgCr₂O₄), MgMn₂O₄, or combinations thereof.

In examples, the cathode 104 is a sintered electrode. In examples, the cathode 104 is unsintered. In examples, the cathode 104 may comprise at least one of an alkali metal or alkaline earth metal. In examples, the cathode 104 may be a fluoride compound. In examples, the cathode 104 may include at least one of lithium, sodium, magnesium, or combinations thereof. In examples, the cathode 104 may also include at least one transition metal, such as cobalt, manganese, nickel, niobium, tantalum, vanadium, titanium, copper, chromium, tungsten, molybdenum, tin, germanium, antimony, bismuth, iron, or combinations thereof.

In examples, the cathode 104 comprises at least one of lithium-based cathode materials or at least one of conversion cathode materials. Conversion cathode materials include fluorides (e.g., AgF, VF₃, FeF₃, etc.), chlorides (e.g., FeCl₃, CuCl₂, etc.), chalcogenides (e.g., S, Li₂S, Se, Li₂Se, Te, Li₂Te, etc.), or combinations thereof.

Various aspects are contemplated herein, several of which are set forth in the paragraphs below. It is explicitly contemplated that any aspect or portion thereof can be combined to form a combination.

Aspect 1. A battery, comprising:
a substrate;
a cathode disposed on the substrate;
at least one interlayer disposed on the cathode;
a solid-state electrolyte (SSE) disposed on the interlayer; and
a lithium anode disposed on the solid-state electrolyte,
wherein the at least one interlayer is a deep-eutectic-solvent-based (DES) electrolyte.

Aspect 2. The battery of aspect 1, or any preceding aspect, wherein the cathode comprises at least one of

lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 3. The battery of aspect 1, or any preceding aspect, wherein the cathode comprises:

lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

Aspect 4. The battery of aspect 1, or any preceding aspect, wherein the deep-eutectic-solvent-based (DES) electrolyte comprises at least one lithium salt and at least one amide compound.

Aspect 5. The battery of aspect 4, or any preceding aspect, wherein the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof.

Aspect 6. The battery of aspect 4 or 5, or any preceding aspect, wherein the at least one amide compound comprises at least one of: R₁-CO-NH-R₂, R₁-O-CO-NH-R₂, NH₂-CO-NH-R₂, NH₂-CS-NH-R₂, wherein R₁ is selected from CH₃-(CH₂)ₙ and CH₂=CH-(CH₂)ₙ, and n is in a range of 0 to 10, and R₂ is selected from H, CH₃, and CH₂-OH.

Aspect 7. The battery of any one of aspects 1-5, or any preceding aspect, wherein the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA).

Aspect 8. The battery of aspect 7, or any preceding aspect, wherein a molar ratio of LiTFSI:NMA is in a range of 1:1 to 1:50.

Aspect 9. The battery of any one of aspects 1-5, or any preceding aspect, wherein the solid-state electrolyte comprises lithium, lanthanum, zirconium, and oxygen elements.

Aspect 10. The battery of aspect 9, or any preceding aspect, wherein the solid-state electrolyte comprises at least one of:
(i) Li₇₋₃ₐLa₃Zr₂LₐOı₂, with L = Al, Ga or Fe and 0 < a < 0.33;
(ii) Li₇La_{3-b}Zr₂M_{b}O₁₂, with M = Bi or Y and 0 < b < 1;
(iii) Li_{7-c}La₃(Zr_{2-c},N_{c})O₁₂, with N = In, Si, Ge, Sn, V, W, Te, Nb, or Ta and 0 < c < 1;
(iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4),
or a combination thereof.

Aspect 11. The battery of any one of aspects 1-5, or any preceding aspect, wherein the battery has a cathode/SSE interfacial resistance of no more than 200 Ω cm² at room temperature and a cycling stability of at least 200 cycles with at least 50% capacity retention.

Aspect 12. The battery of aspect 11, or any preceding aspect, wherein the battery has a cathode/SSE interfacial resistance of no more than 130 Ω cm² at room temperature and a cycling stability of at least 400 cycles with at least 80% capacity retention.

Aspect 13. The battery of any one of aspects 1-5, or any preceding aspect, wherein the at least one interlayer is disposed as an independent layer.

Aspect 14. The battery of any one of aspects 1-5, or any preceding aspect, wherein the at least one interlayer is embedded at a depth within the cathode, or embedded at a depth within the solid-state electrolyte (SSE), or any combination thereof.

Aspect 15. A battery, comprising:
a cathode;
at least one interlayer disposed on the cathode;
a solid-state electrolyte (SSE) disposed on the interlayer,
wherein the at least one interlayer is a deep-eutectic-solvent-based (DES) electrolyte, and
wherein the battery has:
   a cathode/SSE interfacial resistance of no more than 200 Ω cm² at room temperature, and
   a cycling stability of at least 200 cycles with at least 50% capacity retention.

Aspect 16. The battery of aspect 15, or any preceding aspect, wherein the cathode/SSE interfacial resistance is no more than 130 Ω cm² at room temperature and the cycling stability is at least 400 cycles with at least 80% capacity retention.

Aspect 17. The battery of aspect 15, or any preceding aspect, wherein the cathode comprises at least one of

lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

Aspect 18. The battery of aspect 15, or any preceding aspect, wherein the cathode comprises: lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

Aspect 19. The battery of aspect 15, or any preceding aspect, wherein the deep-eutectic-solvent-based (DES) electrolyte comprises at least one lithium salt and at least one amide compound.

Aspect 20. The battery of aspect 19, or any preceding aspect, wherein the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof.

Aspect 21. The battery of aspect 19 or 20, or any preceding aspect, wherein the at least one amide compound comprises at least one of: R₁-CO-NH-R₂, R₁-O-CO-NH-R₂, NH₂-CO-NH-R₂, NH₂-CS-NH-R₂, wherein R₁ is selected from CH₃-(CH₂)ₙ and CH₂=CH-(CH₂)ₙ, and n is in a range of 0 to 10, and R₂ is selected from H, CH₃, and CH₂-OH.

Aspect 22. The battery of any one of aspects 15-20, or any preceding aspect, wherein the at least one interlayer is disposed as an independent layer.

Aspect 23. The battery of any one of aspects 15-20, or any preceding aspect, wherein the at least one interlayer is embedded at a depth within the cathode, or embedded at a depth within the solid-state electrolyte (SSE), or any combination thereof.

Aspect 24. The battery of any one of aspects 15-20, or any preceding aspect, wherein the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA).

Aspect 25. The battery of aspect 24, or any preceding aspect, wherein a molar ratio of LiTFSI:NMA is in a range of 1:1 to 1:50.

Aspect 26. The battery of any one of aspects 15-20, or any preceding aspect, wherein the solid-state electrolyte comprises at least one of:
(i) Li₇₋₃ₐLa₃Zr₂LₐOı₂, with L = Al, Ga or Fe and 0 < a < 0.33;
(ii) Li₇La_{3-b}Zr₂M_{b}O₁₂, with M = Bi or Y and 0 < b < 1;
(iii) Li_{7-c}La₃(Zr_{2-c},N_{c})O₁₂, with N = In, Si, Ge, Sn, V, W, Te, Nb, or Ta and 0 < c < 1;
(iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4),
or a combination thereof.

### EXAMPLES

### Example 1-Preparation of DES Electrolyte

Dry bis(trifluoromethane) sulfonimide lithium salt (LiN(CF₃SO₂)₂, LiTFSI) and N-methylacetamide (C₃H₇NO, NMA) was mixed at varying molar ratios (1:2, 1:4, 1:5, and 1:6, respectively) and dissolved to a clear and transparent solution at 60° C., and then cooled as a liquid state to room temperature.

### Example 2-Preparation of Garnet Pellet Cubic Garnet-Type Solid Electrolyte

Ta-doped garnet (Li_{6.5}La₃Zr_{1.5}Ta_{0.5}O₁₂, LLZTO) was synthesized and sintered into ceramic pellets by traditional solid phase methods, such as high temperature solid-state reaction methods. LiOH·H₂0 (AR), La₂O₃ (99.99%), ZrO₂ (AR) and Ta₂O₅ (99.99%) were mixed by ball milling in a stoichiometric ratio with 10 wt.% excess of LiOH·H₂O. The dry La₂O₃ powder was obtained by heating at 900° C. for 12 hrs. The powder mixture was calcined at 950° C. for 6 hrs in an alumina crucible to obtain a cubic phase LLZTO powder, which is then ball milled at 250 rpm for 24 hrs to obtain refined powder. The prepared LLZTO refined powder was then pressed and calcined at 1250° C. for 30 min in a platinum crucible in air. The pellets were polished and stored in an Ar-filled glove box. The final ceramic pellets are about 1.0 mm thick and about 13.5 mm in diameter.

### Example 3-Preparation LFP/NCM Cathode

A LiFePO₄ (LFP) and LiNi_{0.6}Co_{0.2}Mn_{0.2}O₂ (NCM622) cathode was prepared by slurry coating technique. The LFP/NCM622 powder (active cathode material), super P carbon powder (conductive carbon component), vapor grown carbon fiber (VGCF) (electronic conductive material), and poly(vinylidene fluoride) (PVDF) (or poly(vinylidene fluoride)-hexafluoropropylene (PVDF-HFP)) (polymer binder, “polymer phase”) is mixed at a weight ratio of 8:0.5:0.5:1 in dipolar aprotic organic solvent (e.g., N-methylpyrrolidone (NMP), “solvent phase”) by ball milling for 6 hrs to form a slurry.

In examples, the polymer binder may comprise at least one of: poly(vinylidene fluoride) (PVDF), poly(vinylidene fluoride)-hexafluoropropylene (PVDF-HFP), polyacrylic acid (PAA), polyacrylonitrile (PAN), polymethyl methacrylate (PMMA), polyvinyl formal (PVFM), polyvinyl butyral (PVB), polyvinyl alcohol (PVA), or combinations thereof.

In examples, the mixture comprises at least one of a conductive carbon component, an electronic conductive component, or combinations thereof. In examples, the conductive carbon component and/or the electronic conductive material is independently selected from at least one of nanoparticles, nanowires, nanofibers, nanorods, nanotubes, nanospheres, graphene, carbon black, carbonized cotton fiber, Super P, Ketjen black, vapor grown carbon fiber (VGCF), or combinations thereof. The conductive carbon component and/or the electronic conductive material provide electronic conductivity and ensure good rate capability.

In examples, the active cathode material is contemplated as being LiNi_{d}CoₑMn_{1-d-e}O₂ (NCM) (with 0 < d < 1, 0 < e < 1), LiT_{M}O₂ (with T_{M} = Sc, Ti, V, Mn, Fe, Co, Ni or Cu), Li₂TiO₃, Li₄Ti₅O₁₂, Li₃VO₄, LiMn₂O₄, yLi₂MnO₃•(1-y)LiXO₂ (with X = Ni, Co, or Mn and 0 < y < 1), LiNi_{0.8}Co_{0.15}Al_{0.05}O₂ (NCA), LiNi_{0.5}Mn_{1.5}O₄, LiFePO₄, or combinations thereof. Active cathode materials provide capacity of the battery.

In some examples, the dipolar aprotic organic solvent comprises at least one of: N-methylpyrrolidone (NMP), N,N-dimethylformamide (DMF), dimethyl sulfoxide (DMSO), N,N-dimethylacetamide (DMAC), trimethyl phosphate (TMP), triethyl phosphate (TEP), or combinations thereof. The binder maintains the stability of the electrode structure and prevents the electrode from collapsing and peeling off during the cycling.

In some examples, a weight ratio of active cathode material is in a range of 50% to 95%, a weight ratio of conductive component (e.g., sum of conductive carbon component and electronic conductive material) is in a range of 3% to 30%, and the weight ratio of polymer binder is in a range of 3% to 30%. In some examples, a weight ratio of active cathode material is in a range of 60% to 90%, a weight ratio of conductive component is in a range of 5% to 25%, and a weight ratio of polymer binder is in a range of 5% to 25%. In some examples, a weight ratio of active cathode material is in a range of 70% to 85% (e.g., 70%, 80%, etc.), a weight ratio of conductive component is in a range of 8% to 20% (e.g., 10%, 12%, etc.), and a weight ratio of polymer binder is in a range of 8% to 20% (e.g., 10%, 18%, etc.). In some examples, the solid content of the slurry (i.e., ratio of the sum of the mass of active cathode material, conductive carbon component and/or electronic conductive component, and polymer binder to the total mass of the slurry), is in a range of 20% to 40%.

After mixing, the slurry is coated on an aluminum foil by blade casting.

Optionally, the slurry-coated foil is then directly immersed in a non-solvent (e.g., an alcohol) for about one minute. The alcohol dissolves with NMP and forms a porous cathode structure by phase conversion, in which the anhydrous alcohol is used as a non-solvent. As the slurry-coated foil is immersed into the non-solvent phase, the alcohol gradually permeates into the slurry, first forming an alcohol-polymer-solvent solution and then breaking the thermodynamic equilibrium to form two phases: a polymer-rich phase (mainly binder, active material, and conductive component) and a polymer-poor phase (mainly solvent NMP). The polymer-rich phase solidifies as the skeleton of porous electrodes, while the polymer-poor phase become the pores. The solvent-non-solvent exchange process immediately occurs on a slurry/alcohol interface, which forms the porous skin layer. Below the skin layer, the exchange rate between solvent and non-solvent is much slower, and droplets of polymer-poor phase may aggregate and grow, forming the porous support layer with continuous pores. In examples, the non-solvent comprises at least one of: water, alcohol, methyl alcohol, isopropyl alcohol, glycerol, tetrahydrofuran (THF), or combinations thereof.

Thereafter, the cathode-coated aluminum foil was dried for a period of time in a range of 1 hr to 24 hrs (e.g., 4 hrs) at room temperature, followed by continuously drying under vacuum (at 50° C. to 100° C. (e.g., 65° C.) for 1 hr to 48 hrs (e.g., 24 hrs)). The obtained cathode was cut into 12 mm diameter (Φ) discs.

In embodiments, the cathode has a porosity of at least 5%, at least 10%, or at least 20%, or at least 30%, or at least 40%, or at least 50%, or at least 60%, or at least 70% (e.g., 75%), or at least 80%, or at least 90%, or at least 95%, or any value or range disclosed therein. In embodiments, the cathode has a porosity of at most 80%, or at most 70%, or at most 60%, or at most 50%, or at most 40%, or at most 30%, or at most 20%, or at most 10%, or at most 5%, or any value or range disclosed therein.

In embodiments, the cathode has an average pore size diameter of at least 200 nm, or at least 300 nm, or at least 400 nm, or at least 500 nm, or at least 600 nm, or at least 700 nm, or at least 800 nm, or at least 900 nm, or at least 1000 nm, or at least 1200 nm, or at least 1500 nm, or at least 2000 nm, or any value or range disclosed therein. In embodiments, the cathode has an average pore size diameter of at most 25 nm, or at most 50 nm, or at most 75 nm, at most 100 nm, or at most 200 nm, or at most 300 nm, or at most 400 nm, or at most 500 nm, or at most 600 nm, or at most 700 nm, or at most 800 nm, or at most 900 nm, or at most 1000 nm, or at most 1200 nm, or at most 1500 nm, or at most 2000 nm, or any value or range disclosed therein. In embodiments, the cathode has an average pore size diameter in a range of 25 nm to 500 nm, or 100 nm to 500 nm, or 400 nm to 800 nm, or 800 nm to 1200 nm, or any value or range disclosed therein.

### Example 4-Assembly of Solid-State Battery for Testing

Assembly of solid-state batteries matched with LFP/NCM622 cathode (prepared in Example 3) was completed as follows. Example 4 was performed in an argon-filled glove-box.

First, a fresh Li foil (anode) having a diameter of 12 mm was attached (e.g., melted) to polished solid-state electrolyte (LLZTO, prepared in Example 2) (with gold coating). The LLZTO SSE may be polished using silicon carbide (SiC) sandpaper. Melting of the fresh Li foil may be conducted at a temperature in a range of 250° C. to 400° C. (e.g., 300° C. to 350° C.) for a time in a range of 1 sec to 20 min (e.g., 3 min to 10 min), followed by naturally cooling to room temperature.

In examples, the heating is conducted at a temperature in the range of 250° C. to 400° C., or 275° C. to 375° C., or 300° C. to 350° C. (e.g., 340° C.), or 250° C. to 300° C., or 350° C. to 400° C., or any value or range disclosed therein. In examples, the time is conducted in the range of 1 sec to 20 min, or 30 sec to 15 min, or 1 min to 10 min, or 3 min to 10 min, or 5 min to 10 min, or any value or range disclosed therein.

Second, 20 µL DES electrolyte (prepared in Example 1) was dropped onto the cathode foil, and then the LLZTO (with melted Li) was placed upon the wetted cathode.

All the cells were assembled in CR2025 coin cells. Sealing pressure of the coin cell is in a range of 1 MPa to 10 MPa (e.g., ~5 MPa).

In examples, the formed battery exhibits an impedance below 600 Ω•cm², or below 550 Ω•cm², or below 500 Ω•cm², or below 450 Ω•cm², or below 400 Ω•cm², or below 350 Ω•cm², or below 300 Ω•cm², or below 250 Ω•cm², or below 200 Ω•cm², or below 150 Ω•cm², or below 100 Ω•cm², or below 50 Ω•cm², or any value or range disclosed therein at room temperature. The total impedance of the battery includes bulk impedance of the solid-state electrolyte and the cathode/solid-state electrolyte interfacial impedance; this value is larger than the impedance of the cathode/SSE interface described below.

In examples, the formed battery exhibits a reversible capacity of at least 80 mAh g⁻¹, or at least 100 mAh g⁻¹, or at least 120 mAh g⁻¹, or at least 150 mAh g⁻¹, or at least 180 mAh g⁻¹, or at least 200 mAh g⁻¹, or at least 250 mAh g⁻¹, or any value or range disclosed therein, at first cycle. In examples, batteries with cathodes described herein exhibit an initial discharge capacity of about 160 mAh g⁻¹.

In examples, the formed battery exhibits a capacity retention of at least 40%, or at least 50%, or at least 60%, or at least 70%, or at least 80%, or at least 90%, or at least 95%, or at least 99%, or any value or range disclosed therein, after 400 cycles. In examples, the formed battery exhibits a cathode/SSE interfacial resistance of no more than 500 Ω cm², or no more than 250 Ω cm² (e.g., 130 Ω cm²), or no more than 100 Ω cm², or any value or range disclosed therein.

### Example 5-Characterization Techniques

### Intrinsic Properties of Samples

Thermogravimetric analysis was achieved using a thermogravimetric analyzer (TG, NETZSCH STA 409 PC). Raman spectra of the samples were characterized by variable temperature Raman spectrometer.

Combustion Testing was conducted by dropping 80 µL of electrolyte onto a glass fiber separator (Φ18 mm). The soaked separator was kept under a flame of a lighter for 30 sec to observe whether the electrolyte can be ignited.

### Electrochemical Measurements and Performance

Electrochemical impedance spectroscopy (EIS) were measured on an electrochemical workstation (Autolab PGSTAT302N Netherland) with a frequency range from 10⁵ to 0.1 Hz and an alternating current (AC) amplitude of 10 mV.

All assembled batteries are tested on a battery test system (NEWARE BTS-4000) in a voltage range of from 2.8 V to 4.5 V at room temperature.

### Example 6-Sample Preparation and Characterization

### Sample 1

Dry LiTFSI and N-methylacetamide (NMA) were mixed in the molar ratio of 1:2, and dissolved to a clear and transparent solution at 60° C., as described in Example 1. Thereafter, the liquid state is maintained at room temperature. A steel/DES electrolyte/steel cell was assembled with the prepared DES electrolyte to test ionic conductivity.

### Sample 2

Sample 2 is prepared the same as Sample 1, except that the molar ratio of dry LiTFSI and N-methylacetamide (NMA) is 1:4.

### Sample 3

Sample 3 is prepared the same as Sample 1, except that the molar ratio of dry LiTFSI and N-methylacetamide (NMA) is 1:6.

### Sample 4

Dry LiTFSI and N-methylacetamide (NMA) were mixed in the molar ratio of 1:5, and dissolved to a clear and transparent solution at 60° C., as described in Example 1. Thereafter, the liquid state is maintained at room temperature. A LFP cathode/DES electrolyte/LLZTO/Li battery cell was assembled with the prepared DES electrolyte by first applying 20 µL of the DES electrolyte onto the LFP cathode foil, and then placing the LLZTO with the melted Li upon the wetted cathode, thereby completing the test solid-state cell.

### Sample 5

Sample 5 is prepared the same as Sample 4, except that the cathode is NCM622.

### Comparative Sample 1

Dry LiPF₆ was dissolved into ethylene carbonate (EC) and dimethyl carbonate (DMC) to form a liquid electrolyte. The content of lithium salt is 1 mol/L, and the volume ratio of EC:DMC is 1: 1.

### Characterization

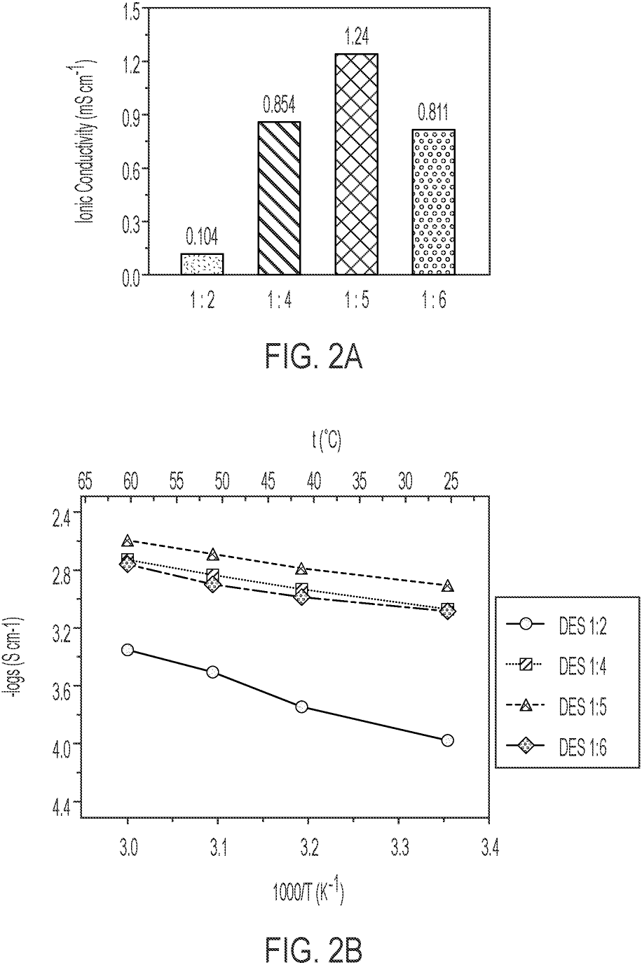

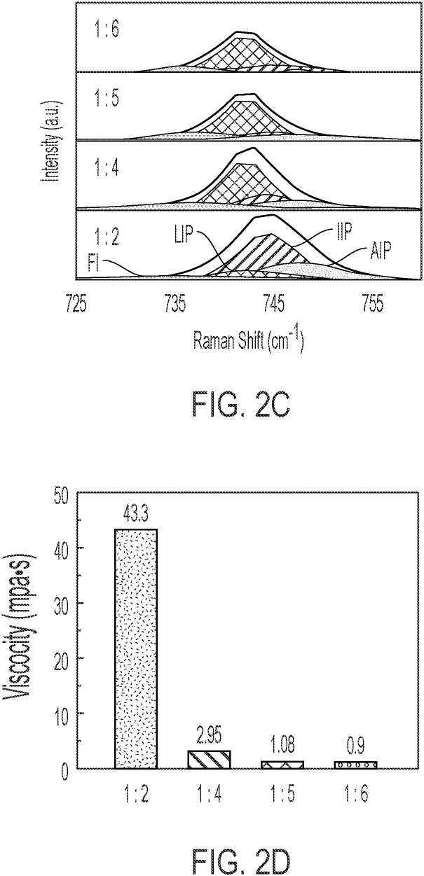

FIGS. 2A and 2B illustrate ionic conductivities of DES electrolytes with varying molar ratios (at room temperature, RT) (FIG. 2A) and varying temperatures (FIG. 2B). When the molar ratio is 1:2 (Sample 1), ionic conductivity is the lowest at 0.104 mS/cm versus when the molar ratio is 1:5 (Sample 4), when the ionic conductivity is the highest at 1.24 mS/cm. Thus, generally speaking, even at varying temperatures, ionic conductivity is higher for samples having higher amounts of NMA at a fixed dry LiTFSI quantity.

The Raman and viscosity results in FIGS. 2C and 2D show that there are more loose ion pairs and free ions in Sample 4 with low viscosity. This indicates that cation-anion interactions are weak and the Li⁺ ions are mostly solvated. The mobility of solvated Li⁺ is much faster than Li⁺ coordinated with anions. The ionic conductivity of DES electrolyte with a molar ratio of 1:5 is higher than that of DES electrolyte with the molar ratio of 1:2 or 1:4. However, when the molar ratio is 1:6, content of lithium salt decreases, indicating that less Li⁺ can provide the ionic conductivity. Thus, Sample 4 with the molar ratio of 1:5 shows highest ionic conductivity at RT.

FIG. 2C shows Raman spectroscopy results of DES electrolytes with different molar ratios. When the molar ratio is 1:2 (Sample 1), aggregated ion pairs (AIP) and intimate ion pairs (IIP) are dominant in LiTFSI. When the molar ratio is 1:4 (Sample 2), there are more loose ion pairs and some intimate ion pairs. When the molar ratio is 1:5 (Sample 4), there are fewer intimate ion pairs and loose ion pairs are dominant. When the molar ratio is 1:6 (Sample 3), the situation is similar to Sample 4.

According to lithium’s coordination number, the cation-anion coordination structure in solution may be described by aggregated ion pairs (AIP) coordinated with more than one Li⁺, intimate ion pairs (IIP) coordinated with one Li⁺, loose ion pairs (LIP) coordinated with less than one Li⁺, and free ions (FI) without Li⁺ coordination. The first three (AIP, IIP, and LIP) are a combination of two ions of opposite charge by electrostatic columbic attraction. AIP and IIP are formed when ions are in direct contact. In contrast, if there are one or more solvent molecules between the cation and anion, the pair is defined as a loose pair, and the intensity of interaction between the two ions with opposite charge depends on the number of solvent molecules. Less AIP and IIP (that is, more LIP and FI) indicates weaker cation-anion interaction and more solvated Li⁺. The ionic conductivity mainly depends on the mobility of solvated Li ions.

FIG. 2D shows viscosity of DES electrolytes with different molar ratios. When the molar ratio is 1:2 (Sample 1), viscosity is very high and fluidity is very poor. As quantities of NMA increase, viscosity decreases drastically (e.g., at molar ratios of 1:4, 1:5 and 1:6, viscosity reduces to 2.95 mPa·s, 1.08 mPa·s, and 0.9 mPa·s, respectively). Lower viscosity indicates higher degree of Li⁺ solvation. Solvated Li⁺ provides ionic conductivity, so Samples 4 (1:5) and 3 (1:6) show higher ionic conductivity. Thus, Sample 4 has a higher ratio of lithium salt; more Li⁺ provides higher ionic conductivity. Though Samples 4 (1:5) and 3 (1:6) both have small viscosity and dominant loose ion pairs, Sample 4 has more lithium salts and brings in higher ionic conductivity.

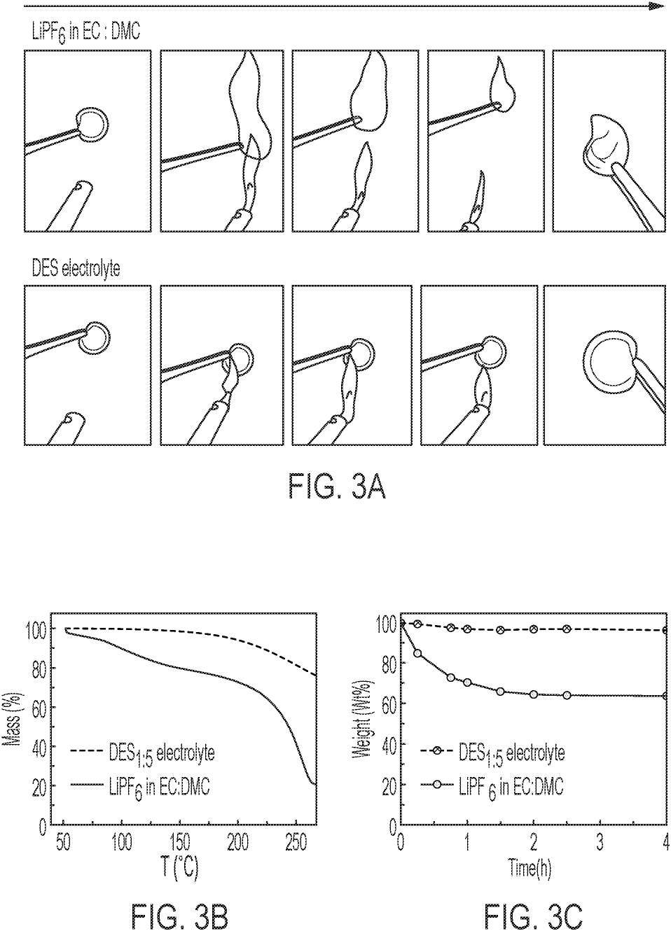

FIG. 3A is a schematic representation of optical images of LiPF₆ in ethylene carbonate (EC) / dimethyl carbonate (DMC) electrolyte and DES electrolyte under a combustion test. FIG. 3B illustrates mass loss curves of LiPF₆ in EC/DMC electrolyte and DES electrolyte at different temperatures. DES electrolyte is not ignited (bottom row of FIG. 3A) and undergoes negligible weight loss at temperature up to 200° C., as shown in FIG. 3B. In contrast, conventional 1M LiPF₆ in EC/DMC liquid electrolyte (Comparative Sample 1) is highly combustible (top row of FIG. 3A) and undergoes rapid weight loss, as demonstrated in the thermogravimetric curves, down to about 70 mass% at 200° C. High safety is an important advantage of solid-state batteries. Flammable liquid organic electrolyte causes safety hazards. The combustion test verifies that DES electrolytes are not ignited easily, indicating high thermal safety. Thus, solid state batteries with thermally safe DES electrolyte at the cathode/SSE interface can ensure its high safety.

FIG. 3C illustrates mass loss curves of LiPF₆ in EC/DMC electrolyte and DES electrolyte at RT in the air. These two liquid electrolytes also have different evaporation rates in air at room temperature. Conventional 1M LiPF₆ in EC/DMC liquid electrolyte evaporates quickly, leveling off at about 60 wt.% after about 1.5 hrs, owing to the low boiling point of the carbonate solvent. In contrast, DES electrolyte negligibly evaporates even after 4 hrs. Thermal stability is also important for Li⁺ electrolytes. Evaporation of carbonate solvent with low boiling point leads to gas release, causing battery bulge, which is another safety issue. The evaporation experiments verify that DES electrolytes show high thermal stability, which ensures nearly zero or negligible gas release during cycling.

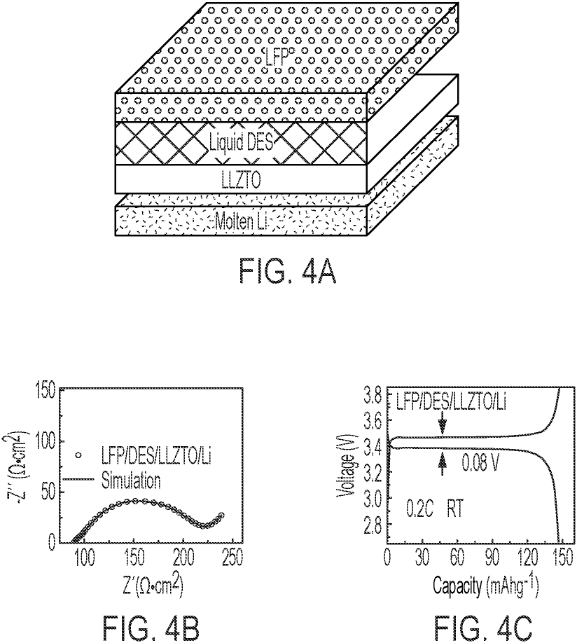

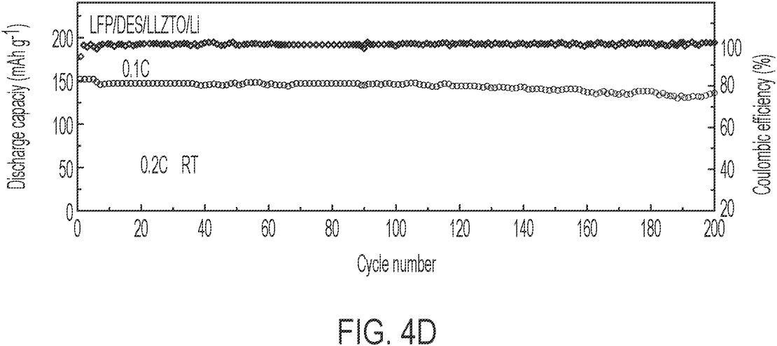

FIG. 4A illustrates a schematic diagram of a full battery with DES electrolyte at LFP/SSE interface in Sample 4. FIG. 4B illustrates an EIS spectrum and FIG. 4C illustrates a voltage-capacity curve of a LFP/DES/LLZTO/Li cell; and FIG. 4D illustrates long-term cycling performance of the LFP/DES/LLZTO/Li cell at RT. Interfacial resistance is tested to be ~130 Ω cm², as shown in FIG. 4B. In contrast, the resistance is too large to be tested when no DES electrolyte is added at the interface. Voltage-capacity curves of FIG. 4C indicate small voltage polarization of the cell at 0.2C, suggesting well wetted cathode/SSE interface. FIG. 4D shows the long-term cycling performance of the LFP/DES/LLZTO/Li cell at RT. The cell can cycle stably for over 200 times without obvious capacity decay.

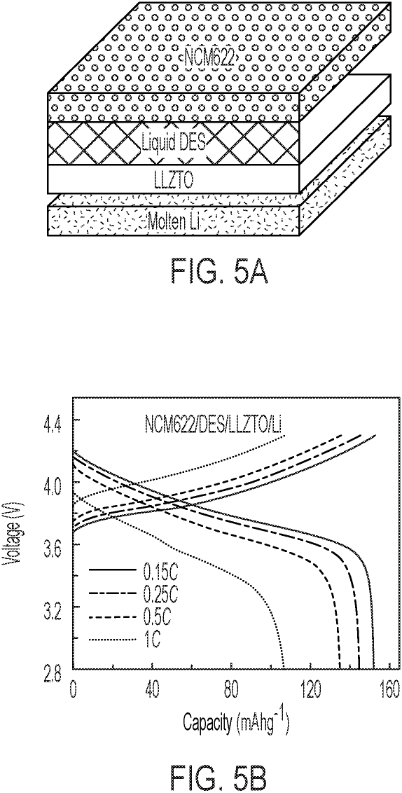

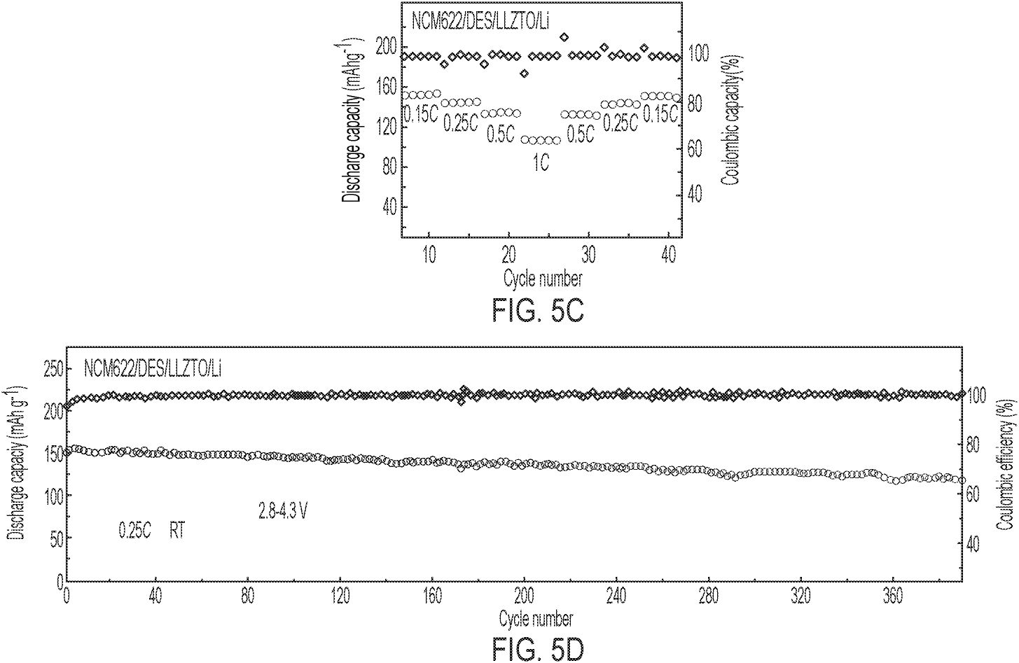

FIG. 5A illustrates a schematic diagram of a full battery with DES electrolyte at NCM/SSE interface in Sample 5. FIG. 5B illustrates voltage-capacity curves of a NCM622/DES/LLZTO/Li cell at different rates. The cell discharges at about 152 mAh/g, at about 144 mAh/g, at about 133 mAh/g, and at about 106 mAh/g capacity at rate of 0.15C, 0.25C, 0.5C, and 1C, respectively, during 2.8-4.3 V at 25° C., as shown in FIG. 5B. Cycling performance of the NCM622/DES/LLZTO/Li cell is illustrated at different rates (FIG. 5C) and at 0.25C at RT (FIG. 5D). The capacity reversibility and rate capability is good, as shown in FIG. 5C, where the cell is tested at different rates. In other words, the battery can discharge over 155 mAh g⁻¹ at 0.15C, ~145 mAh g⁻¹ at 0.25C and ~135 mAh g⁻¹ at 0.5C, and can discharge ~106 mAh g⁻¹ even at 1C. Discharge capacity is reversible after cycling at different rates.] The battery shows a good cycling stability of ~400 cycles at 0.25C at RT and still maintains ~80% capacity retention (FIG. 5D).

Thus, as presented herein, this disclosure relates to improved deep eutectic solvent-based (DES) electrolytes for cathode/solid electrolyte interfaces in solid-state battery applications. DES electrolytes, including lithium salts and amide compounds, have low vapor pressure, low cost, non-flammability and biodegradability. Melting points of DES electrolytes are lower than those of each individual component owing to intermolecular hydrogen bonds between lithium salt as a hydrogen-bond acceptor and amide compounds as a hydrogen-bond donor, thereby enabling the DES electrolyte to remain in a liquid state at room temperature. With DES electrolytes at the cathode/SSE interface, solid-state batteries may achieve greatly reduced interfacial resistance of ~130 Ω cm² at RT and excellent cycling stability for ~400 cycles with ~80% capacity retention.

Inorganic binders or polymer electrolytes introduced at the cathode/SSE interface in current technologies have smaller ionic conductivity at room temperature while still having a large interfacial resistance. Ionic liquid electrolytes can effectively reduce interfacial resistance, but are expensive and not desirable for large-scale applications. In contrast, advantages of the DES electrolyte disclosed herein include (1) having high ionic conductivity (in the range of ms/cm), low cost, non-flammability, biodegradability; (2) remaining at a liquid state at RT and providing continuous and uniform ion paths at the interface and inside the cathode; (3) greatly reducing the cathode/SSE interfacial resistance (~130 Ω cm² at RT); and helping to improve cycling performance of solid state batteries.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A battery, comprising:
a substrate;
a cathode disposed on the substrate;
at least one interlayer disposed on the cathode;
a solid-state electrolyte (SSE) disposed on the interlayer; and
a lithium anode disposed on the solid-state electrolyte,
wherein the at least one interlayer is a deep-eutectic-solvent-based (DES) electrolyte.

2. The battery of claim 1, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

3. The battery of claim 1, wherein the cathode comprises:
lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

4. The battery of claim 1, wherein the deep-eutectic-solvent-based (DES) electrolyte comprises at least one lithium salt and at least one amide compound.

5. The battery of claim 4, wherein the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof.

6. The battery of claim 4, wherein the at least one amide compound comprises at least one of: R₁-CO-NH-R₂, R₁-O-CO-NH-R₂, NH₂-CO-NH-R₂, NH₂-CS-NH-R₂, wherein R₁ is selected from CH₃-(CH₂)ₙ and CH₂=CH-(CH₂)ₙ, and n is in a range of 0 to 10, and R₂ is selected from H, CH₃, and CH₂-OH.

7. The battery of claim 1, wherein the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA).

8. The battery of claim 7, wherein a molar ratio of LiTFSI:NMA is in a range of 1:1 to 1:50.

9. The battery of claim 1, wherein the solid-state electrolyte comprises lithium, lanthanum, zirconium, and oxygen elements.

10. The battery of claim 9, wherein the solid-state electrolyte comprises at least one of:
(i) Li₇₋₃ₐLa₃Zr₂LₐO₁₂, with L = Al, Ga or Fe and 0 < a < 0.33;
(ii) Li₇La_{3-b}Zr₂M_{b}O₁₂, with M = Bi or Y and 0 < b < 1;
(iii) Li_{7-c}La₃(Zr_{2-c},N_{c})O₁₂, with N = In, Si, Ge, Sn, V, W, Te, Nb, or Ta and 0 < c < 1;
(iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4),
or a combination thereof.

11. The battery of claim 1, wherein the battery has a cathode/SSE interfacial resistance of no more than 200 Ω cm² at room temperature and a cycling stability of at least 200 cycles with at least 50% capacity retention.

12. A battery, comprising:
a cathode;
at least one interlayer disposed on the cathode;
a solid-state electrolyte (SSE) disposed on the interlayer,
wherein the at least one interlayer is a deep-eutectic-solvent-based (DES) electrolyte, and
wherein the battery has:
a cathode/SSE interfacial resistance of no more than 200 Ω cm² at room temperature, and
a cycling stability of at least 200 cycles with at least 50% capacity retention.

13. The battery of claim 12, wherein the cathode comprises at least one of
lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0 < d < 1, 0 < e < 1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

14. The battery of claim 13, wherein the cathode comprises: lithium nickel manganese cobalt oxide (NCM) (LiNi_{d}CoₑMn_{1-d-e}O₂, where 0 < d < 1, 0 < e < 1) and lithium iron phosphate (LiFePO₄) (LFP).

15. The battery of claim 12, wherein the deep-eutectic-solvent-based (DES) electrolyte comprises at least one lithium salt and at least one amide compound.

16. The battery of claim 15, wherein the at least one lithium salt comprises at least one of: lithium bis(trifluoromethanesulfonyl)imide (LiTFSI), lithium bis(fluorosulfonyl)imide (LiFSI), lithium trifluoromethanesulfonate (LiOTf), lithium chloride (LiCl), lithium hexafluorophosphate (LiPF₆), lithium polysulfide, lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), or combination thereof.

17. The battery of claim 16, wherein the at least one amide compound comprises at least one of: R₁-CO-NH-R₂, R₁-O-CO-NH-R₂, NH₂-CO-NH-R₂, NH₂-CS-NH-R₂, wherein R₁ is selected from CH₃-(CH₂)ₙ and CH₂=CH-(CH₂)ₙ, and n is in a range of 0 to 10, and R₂ is selected from H, CH₃, and CH₂-OH.

18. The battery of claim 12, wherein the deep-eutectic-solvent-based (DES) electrolyte comprises bis(trifluoromethane) sulfonimide lithium salt (LiN(CF₃SO₂)₂, LiTFSI) and N-methylacetamide (C₃H₇NO, NMA).

19. The battery of claim 18, wherein a molar ratio of LiTFSI:NMA is in a range of 1:1 to 1:50.

20. The battery of claim 12, wherein the solid-state electrolyte comprises at least one of:
(i) Li₇₋₃ₐLa₃Zr₂LₐO₁₂, with L = Al, Ga or Fe and 0 < a < 0.33;
(ii) Li₇La_{3-b}Zr₂M_{b}O₁₂, with M = Bi or Y and 0 < b < 1;
(iii) Li_{7-c}La₃(Zr_{2-c},N_{c})O₁₂, with N = In, Si, Ge, Sn, V, W, Te, Nb, or Ta and 0 < c < 1;
(iv) protonated LLZO (e.g., Hₓ-Li_{6.5-x}La₃Zr_{1.5}I_{0.5}O₁₂, with I = In, Si, Ge, Sn, V, W, Te, Nb, or Ta and 0 < x < 4 or Hₓ-Li_{6.25-x}E_{0.25}La₃Zr₂O₁₂, with E = Al, Ga or Fe and 0 < x < 4),
or a combination thereof.
